(19) United States
(12) Patent Application Publication
(10) Pub. No.: US 2011/0095993 A1
(43) Pub. Date: Apr. 28, 2011

(54) ZOOM ADJUSTMENT PROCESS

(75) Inventor: Dave Zuverink, San Jose, CA (US)

(73) Assignee: Adobe Systems Incorporated, San Jose, CA (US)

(21) Appl. No.: 12/605,587

(22) Filed: Oct. 26, 2009

(51) Int. Cl. G06F 3/041

(52) U.S. Cl. 345/173

(57) ABSTRACT

Subject matter, for example, disclosed herein relates to an embodiment of a process, system, device, or article for adjusting zoom level of displayed electronic content.

### BACKGROUND

1. Field

Subject matter disclosed herein relates to a process for adjusting zoom level of displayed electronic content.

2. Information:

As portable, handheld electronic devices continue to decrease in size and increase in capability, displays of such devices tend to play a larger part as a graphical user interface (GUI) for the device. For example, such electronic devices may run multiple applications while relying on a touch screen for user input to one or more running applications. With such increased display activity, strategic use of display area or techniques for entering user input information may become more desirable.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIGS. 1 and 2 are representations of a screenshot view of a user display, according to an embodiment.

FIG. 3 is a representation of a display that includes a zoom control, according to an embodiment.

FIG. 4 is a flow diagram of a zoom adjustment process, according to an embodiment.

FIG. 5 is a schematic diagram illustrating an example embodiment of a computing system.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some portions of the following detailed description are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perfoini particular operations pursuant to instructions from program software. Algorithmic descriptions or symbolic representations are examples of techniques used by those of ordinary skill in signal processing or related arts to convey the substance of their work to others skilled in such art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

The terms, “and,” “and/or,” and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, particular features, structures, or characteristics may be combined in one or more embodiments. Embodiments described herein may include machines, devices, engines, or apparatuses that operate using digital signals. Such signals may comprise electronic signals, optical signals, electromagnetic signals, or any form of energy that provides information between locations, for example.

In one or more embodiments, a graphical user interface (GUI) may refer to a program interface that utilizes displayed graphical information to allow a user to control or operate a special purpose computing platform, for example. A pointer may refer to a cursor or other symbol that appears on a display that may be moved or controlled with a pointing device to select objects or input commands via a GUI of a special purpose computing platform, for example. A pointing device may refer to a device used to control a cursor, to select objects, or to input information, such as commands, for example, via a GUI of a special purpose computing platform. Such pointing devices may include, for example, a mouse, a trackball, a track pad, a track stick, a keyboard, a stylus, a digitizing tablet, or similar types of devices. A cursor may refer to a symbol or a pointer where an input selection or actuation may be implemented by a GUI, for example. Herein, terms such a “click” or “clicking” may refer to a selection process made by any pointing device, such as a mouse for example, but use of such terms is not intended to be so limited. For example, a selection process or adjustment may be made via a touch screen. Herein, where a touch screen is used, “clicking” may be replaced by “touching.” Also, in the case of a touch screen, it is to be understood that either a user's finger, thumb, or other object, such as a stylus, may be used to touch and operate the touch screen, though only the word “finger” may be used in the descriptions below. Of course, these are merely examples of methods of selecting objects or inputting information and claimed subject matter is not limited in scope in these respects.

In an embodiment, a displayed zoom control may provide a convenient zoom adjustment process to allow a user to select a rate, such as coarse or fine, for example, of such a zoom adjustment. Convenient implementation of such a process may be realized in one particular embodiment by a radial zoom control that is responsive to a location along a radius of the radial zoom control at which in one particular embodiment a user may select to rotate the radial zoom control. For example, a user, via a mouse, may rotate a displayed radial zoom control by clicking on the radial zoom control at a particular radius and subsequently dragging a mouse-operated cursor in a direction at least somewhat tangential to a circumference of the radial zoom control. Such rotation at a particular radius may result in an adjustment of zoom of displayed electronic content at a particular rate. Similarly, such rotation at a different radius of the radial zoom control may result in an adjustment of zoom of displayed electronic content at a different rate. Accordingly, such a zoom adjustment process may provide an opportunity for a user to at least implicitly select a rate, or sensitivity, at which electronic content zooms in or out in relation to rotation speed of a radial zoom control.

In other embodiments, such a displayed zoom control may readily lend itself to applications involving touch screens. For example, touch screen displays may be utilized in handheld mobile devices, such as personal digital assistant (PDA), navigation devices, cellular telephones, or the like. In the case of a touch screen, for example, a user may rotate a displayed radial zoom control by touching the radial zoom control at a particular radius and subsequently dragging a finger in a direction at least somewhat tangential to a circumference of the radial zoom control. As described above, applying rotation at such a particular radius may result in an adjustment of zoom of displayed electronic content at a particular rate. Similarly, touching and dragging a radial zoom control at a different radius may result in an adjustment of zoom at a different rate.

In one implementation, a zoom control may be used to adjust a zoom level of electronic content comprising a map. Such a zoom control may be used before, during, or after interacting with a panning function for the map. Of course, such a palming function or zoom control may be applied to electronic content other than a map, such as documents, text, graphics, photographs, web pages, video, and so on, though claimed subject matter is not so limited. Here, panning refers to selecting a particular portion of displayed electronic content to be centered or particularly positioned in a display. For example, a user may “drag” displayed electronic content rightward to shift a left portion of displayed electronic content toward the center of the display. Panning, zooming, selecting, or adjusting displayed electronic content may be referred to as navigating a display.

Providing an opportunity for a user to conveniently select a rate of zoom adjustment may offer benefits while navigating a display. For example, a user may pan to a desired portion of a displayed map, and then slowly zoom in on the map to find a compromise between seeing fine map details and maintaining a desired map range display. In contrast, a user may instead rapidly zoom in on a map to quickly obtain fine map details. Of course, such a description of a zoom process and its benefits for one particular embodiment is merely an example, and claimed subject matter is not necessarily so limited.

Embodiments of a zoom control may also provide benefits including an ability of a user to operate the zoom control using one hand (e.g., operating a touch screen) while using the same hand to hold a device on which the zoom control resides. For example, a user may hold a portable, handheld device in a right hand while reaching around with the thumb of the right hand to navigate a display of the device. Techniques described herein for selecting or operating a zoom control may facilitate operating the zoom control one-handedly in such a fashion. Likewise, in an embodiment in which a zoom control is radial, such benefits may be even clearer.

In one embodiment, a user may select a shape, for example, of a zoom control. As mentioned above, such a shape may comprise a radial shape. Other examples may include a rectangular shape or a bar shape, just to name a few possibilities. A radial zoom control, for example, may be facilitated, at least in part, by a special purpose computer platform, which may host one or more applications to display electronic content, overlay a radial zoom control on at least a portion of displayed electronic content, or adjust a zoom level of electronic content in response to a user interacting with the radial zoom control. Such a radial zoom control may comprise a “soft” dial, for example, that may appear to a user to have features similar to a physical dial, but is merely an image in a display. In one particular implementation, a display size of such a soft dial may change according to whether a user is operating the soft dial. For example, a display size of a soft dial may increase upon being selected by a user or decrease after a period of inactivity. A user may navigate a pointer or touch a display where such a soft dial is located to select or operate the soft dial, such as to rotate the soft dial. For example, sensors within a device may be responsive to clicking or dragging a pointing device or tapping or dragging a finger or stylus on a display of the device at a location of the soft dial in the display in order to initiate a rotation of the soft dial. As discussed above, a rate of change of zoom level of electronic content may be based, at least in part, on a radius of the radial zoom control at which a user rotates the radial zoom control. Accordingly, a special purpose computer platform may comprise a display or a GUI to display visual content or detect a radial position where a user rotates the radial zoom control. Such detection, in the case of a touch screen, for example, may be based, at least in part, on capacitive coupling between a user's finger and the touch screen. However, other particular approaches may also be employed, and are intended to be within the scope of claimed subject matter. Of course, a device and a display incorporated in the device are typically specific hardware, whereas a GUI is typically an application designed to be executed by the specific hardware. For example, such an application may comprise a network browser or a similar application that enables the device to interact with display information located on a network, such as the Internet. Of course, various embodiments of a device and associated GUI are possible and it is not intended to limit claimed subject matter to a particular embodiment. Nonetheless, a variety of possible embodiments are described below without intending to be limiting in any way. Such a device may, for example, in one embodiment comprise a special purpose machine capable of executing instructions represented by digital signals.

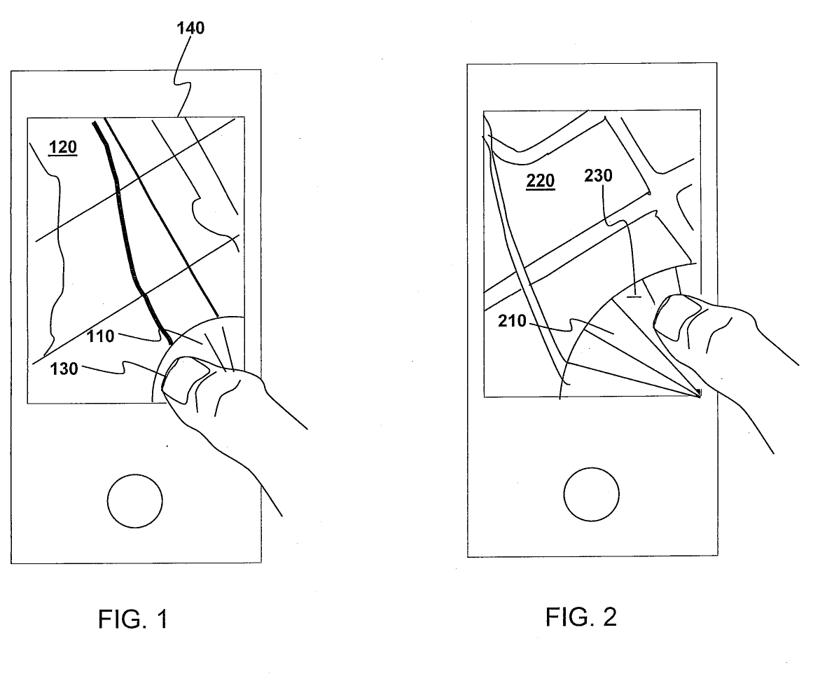

FIGS. 1 and 2 are representations of screenshots of a display, according to an embodiment. For example, display 140 may include electronic content 120, such as a map, a photo, text, or the like. A radial zoom control 110 may be overlaid on at least a portion of electronic content 120 and positioned in a lower-right corner of display 140. In one implementation, a location of radial zoom control 110 may be switched from one edge or corner of display 140 to another edge or corner in response to a user physically touching a portion of display 140. For example, if a left-handed user receives a handheld device from a right-handed user, radial zoom control 110 may switch from a right edge of display 140 to a left edge of display 140 in response to a left-handed user touching a left portion of display 140. In another implementation, a location of radial zoom control 110 may be selected by a user as a user preference. In the case where display 120 is touch sensitive, a user may use a finger 130 to select or rotate radial zoom control 110.

As explained in detail below, in one particular embodiment, if a user touches radial zoom control 110 for an extended time period, radial zoom control 110 may increase in size to radial zoom control 210, shown in FIG. 2, for example. Such a larger size may be easier for a user to operate or manipulate compared to a smaller-sized radial zoom control, for example. Accordingly, a larger-sized radial zoom control may be easier for a user to adjust zoom level. A rate at which zoom level may adjust may depend, at least in part, on a two-dimensional position at which a user selects to adjust a zoom control. In particular, as described in further detail below, a rate at which zoom level may adjust may depend, at least in part, on the radial position at which a user selects to rotate a radial zoom control. A two-dimensional position refers to a position that may be described or defined by two coordinates, two dimensions, a horizontal and a vertical position, an angle and a radius, and so on. A symbol or icon 230 may indicate to a user whether radial zoom control 210 is currently operating to increase or decrease zoom level of electronic content 220. Of course, such details of a zoom control are merely examples, and claimed subject matter is not so limited.

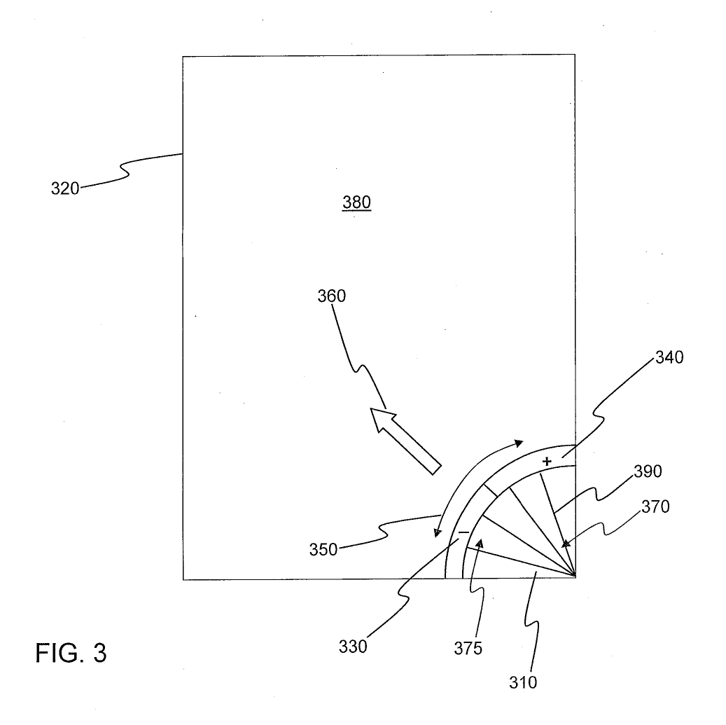

FIG. 3 is a schematic representation of a display that includes a radial zoom control, according to an embodiment. Radial zoom control 310 may be positioned in a corner of a display 320. In a particular implementation, radial zoom control 310 may comprise substantially one-quarter of a circular shape, for example. In the case of a touch screen, for example, a user may operate radial zoom control 310 by touching substantially any portion of the radial zoom control. In one implementation, radial zoom control 310 may comprise a zoom-in portion 340 and a zoom-out portion 330, indicated by a respective symbol or icon as shown in the figure, for example. In one particular implementation, selecting (e.g., touching) such zoom in/out portions may configure radial zoom control 310 into a dedicated zoom-in or zoom-out control. For example, selecting zoom-in portion 340 may configure radial zoom control 310 to increase zoom level of displayed electronic content in response to a user rotating radial zoom control 310 either clockwise or counterclockwise, indicated in FIG. 3 by arrow 350. In such a case, in order to switch zoom direction or cancel a current zoom direction, a user may double-click or double-tap, for example, in a display region over radial zoom control 310. In another case, switching zoom direction or cancelling a current zoom direction may be implemented as a user moves a pointer or finger to another portion of zoom control 310 or away from zoom control 310, though claimed subject matter is not so limited.

In another particular implementation, zoom level of displayed electronic content may increase in response to a user rotating radial zoom control 310 clockwise while zoom level may decrease in response to a user rotating radial zoom control 310 counterclockwise.

As mentioned earlier, a radial zoom control may increase in size in response to a user selecting or operating the radial zoom control. In one particular implementation, radial zoom control 310 may increase in size, as indicated in FIG. 3 by arrow 360, if a user allows a cursor to hover or if the user touches a screen over a display region that includes at least a portion of radial zoom control 310. Such a size increase may, for example, occur after a relatively short delay (e.g., one or two seconds). While a relatively small radial zoom control may occupy less display area, such a size increase may allow radial zoom control 310 to be more easily manipulated than if the radial zoom control remained smaller. Subsequently, radial zoom control 310 may be rotated counterclockwise to decrease a zoom level of displayed electronic content 380, rotated clockwise to increase a zoom level of displayed electronic content 380, or vise versa. Symbols in zoom-in portion 340 and zoom-out portion 330 may indicate to a user whether rotating the radial zoom control increases or decreases zoom level. For example, a “−” may appear in display 320 if a user rotates radial zoom control 310 in a counterclockwise direction, whereas a “+” may appear in display 320 if a user rotates radial zoom control 210 in a clockwise direction.

In one implementation, radial zoom control 310 may include radial lines 390 that rotate as radial zoom control 310 rotates. Such radial lines 390 may indicate to a user rotation of radial zoom control 310.

As mentioned above, a rate at which zoom level adjusts may depend, at least in part, on the radial position at which a user selects to rotate a radial zoom control. For example, a user rotating radial zoom control 310 at radial portion 370 may adjust a zoom level relatively rapidly compared to rotating radial zoom control 310 at a larger radial portion 375. In other words, rotating at a relatively small radial portion 370 may provide rapid and coarse zoom level adjustment, whereas rotating at a relatively large radial portion 375 may provide slow and fine zoom level adjustment. Meanwhile, in order to indicate rotation speed, in one implementation, radial lines 390 may rotate at a rate corresponding to a radial portion at which a user rotates radial zoom control. In a particular implementation, rotation speed of a radial zoom control in a display or zoom level may be indicated in a portion of the display, such as in a lower portion of the display, though claimed subject matter is not so limited. For example, one or more numbers may represent such a rotation speed or zoom level as a relative percentage value. In a particular example, a rotation speed may be expressed as a scale change per unit time, such as one kilometer per inch (scale change) per second (time). Such a rotation speed may also comprise a positive or negative value to indicate whether a radial zoom control is rotating clockwise or counterclockwise, for example. Of course, details of such an indication of rotation speed are merely examples, and claimed subject matter is not so limited.

Due to an unsteady or imprecisely-guided hand, for example, a radial position selected by a user may drift or vary as the user rotates radial zoom control 310. Such a radial variation may also be intentional. In one implementation, such a variation may be disregarded in terms of determining a zoom level rate of change. In such a case, the original radial position may be considered in determining a constant zoom level rate of change during user rotation of the radial zoom control 310. A subsequent user action, such as a double-click or double-tap, may cancel or reset such a constantly-applied zoom level rate of change. In another implementation, such a variation may be considered in determining a zoom level rate of change during user rotation of the radial zoom control 310. In such a case, for example, changing a radial position may result in changing a zoom level rate of change. In other words, the rate at which a zoom level changes may correspond relatively quickly to a radial position selected by a user.

In an embodiment, radial zoom control 310 may be partially or fully translucent or transparent with respective to underlying displayed electronic content. Such translucence may also be adjustable as a user option, for example. In another embodiment, radial zoom control 310 may be displayed occasionally or intermittently. For example, a displayed radial zoom control may disappear from display 320 after a relatively short period during which a user interacts with such a radial zoom control. Such a radial zoom control need not be visible in order to retain its functionality: a user may touch a screen or adjust cursor position in such a fashion as if radial zoom control 310 were visible. Accordingly, displayed electronic content need not be covered by a radial zoom control while such zoom functionality may remain available to a user. A benefit of a concealed, invisible, or intermittently displayed radial zoom control may include providing an increased display area for electronic content.

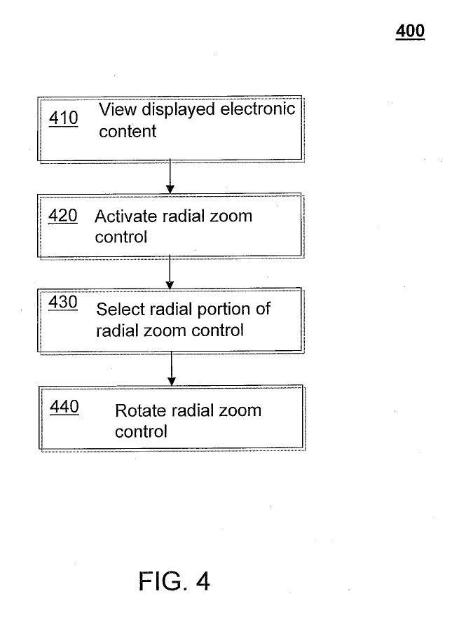

FIG. 4 is a flow diagram of a zoom adjustment process 400, according to an embodiment. At block 410, a user may run one or more applications, such as a Web browser for example, on a computing device. A display coupled to such a computing device may show resulting electronic content. For example, a user may browse the Web to retrieve a map, which may be shown on a display as a result. The user, however, may desire to adjust a magnification or zoom level of the map in order to view greater detail or, conversely, more map coverage. At block 420, the user may activate a zoom control, such as zoom control 310 shown in FIG. 3 for example. Such activation may result from a user selecting a zoom control, which may comprise holding a pointer or finger over a zoom control or double-clicking or tapping such a control in a display. Prior to such activation, a radial zoom control may be displayed so as to have reduced obtrusiveness: such a radial zoom control may be displayed as a relatively small symbol or icon, displayed with relatively high transparency, at least partially concealed beyond an edge of a display, or invisible, as described above for example. At block 430, a user may select a particular radial portion of a radial zoom control to rotate the radial zoom control. At block 440, a user may rotate such a radial zoom control by dragging a pointer, finger, or icon in a substantially clockwise or counterclockwise direction, as described above.

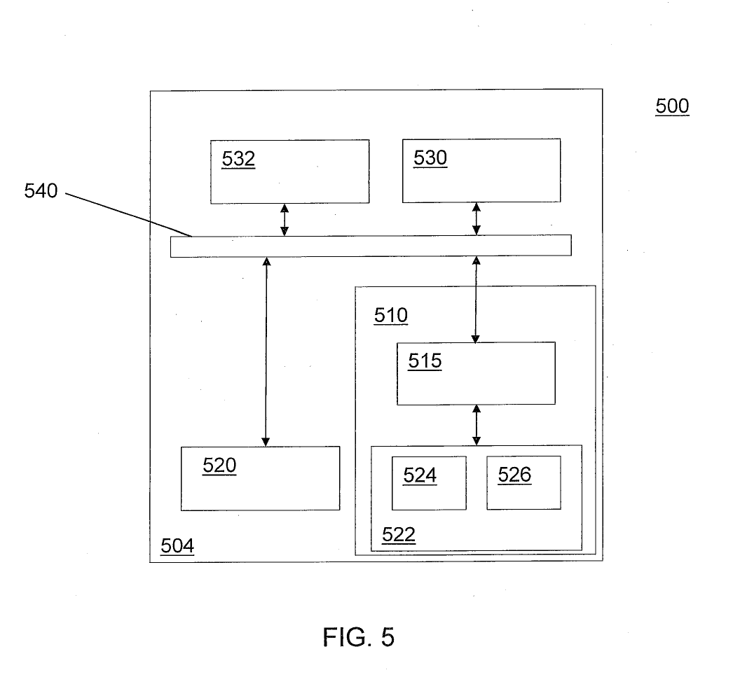

FIG. 5 is a schematic diagram illustrating an example embodiment of a computing system 500 comprising a computing device 504 coupled to a display 530. Computing system 500 may comprise a handheld mobile device, such as a PDA, a navigation device, or a cellular telephone, just to name a few examples. Computing device 504 may comprise one or more processors, for example, to execute code or an application to implement a zoom control for display 530, such as, for example, in a previously described embodiment. For example, such code may comprise a special purpose multimedia computer platform, such as Flash® multimedia platform, available from Adobe Systems Incorporated of San Jose, Calif. Of course, all or part of various devices shown in system 500, and processes and methods as described herein, may be implemented using hardware, firmware, software, or any combination thereof, although claimed subject matter is not intended to cover software per se.

In an embodiment, computing device 504 may include at least one processing unit 520 that is operatively coupled to memory device 510 through a bus 540 and a host or memory controller 515. Processing unit 520 is representative of one or more circuits to perform at least a portion of a data computing procedure or process. By way of example, but not limitation, processing unit 520 may include one or more processors, controllers, microprocessors, microcontrollers, application specific integrated circuits, digital signal processors, programmable logic devices, field programmable gate arrays, the like, or any combination thereof. Processing unit 520 may include an operating system executable to communicate with memory controller 515. Such an operating system may, for example, generate commands to be sent to memory controller 515 over bus 540.

In one implementation, memory device 510, which may include a memory controller 515 and a memory 522, may be used to store executable code such as for a multimedia platform, which may comprise one or more system or user applications, or user settings, just to name a few examples. Memory 522 may be representative of any data storage mechanism. Memory 522 may include, for example, a primary memory 524 or a secondary memory 526. Primary memory 524 may include, for example, a random access memory, read only memory, etc. While illustrated in this example as being separate from processing unit 520, it should be understood that all or part of primary memory 524 may be provided within or otherwise co-located/coupled with processing unit 520, for example. Secondary memory 526 may include, for example, the same or similar type of memory as primary memory or one or more data storage devices or systems, such as, for example, a disk drive, an optical disc drive, a tape drive, a solid state memory drive, etc.

Computing device 504 may include, for example, input/output device 532. Input/output device 532 may be representative of one or more devices or features to accept or otherwise introduce human or machine-generated input information, or one or more devices or features to deliver or otherwise provide for human or machine-generated output information. By way of example, but not limitation, input/output device 532 may include an operatively coupled speaker, keyboard, mouse, trackball, data port, touch screen, etc. Display 530 may comprise a liquid crystal display (LCD), a touch screen display, just to name a few examples.

In one implementation, executing a multimedia platform, such as Flash® multimedia platform, may provide a GUI that includes a timeline or other displayed features on display 530 that may be operated to adjust a zoom level of displayed content in response to a user adjusting a position of one or more of such displayed features. In another implementation, executing such a multimedia platform may provide a programming environment that may be used to associate a user's screen input information, via input/output device 532, for example, to a zoom level of displayed content. For example, a programming environment may operate so that sliding a finger clockwise by an amount corresponding to a certain number of radial degrees will in turn increase a zoom level by a certain percentage. Such a ratio of sliding movement to zoom level may be pre-programmed or set as a preference by a user. Of course, other applications or computer platforms may be used, and claimed subject matter is not limited to examples such as those provided above.

It will, of course, also be understood that, although particular embodiments have just been described, claimed subject matter is not limited in scope to a particular embodiment or implementation. For example, one embodiment may be in hardware, such as implemented on a device or combination of devices, as previously described, for example. Likewise, although claimed subject matter is not limited in scope in this respect, one embodiment may comprise one or more articles, such as a storage medium or storage media, as described above, for example, comprising machine-readable instructions stored thereon that, in response to being executed by a special purpose computing device, are adapted to enable said special purpose computing device to initiate an embodiment of a method in accordance with claimed subject matter being executed, such as one of the embodiments previously described, for example. As one potential example, a specific or special purpose computing platform may include one or more processing units or processors, one or more input/output devices, such as a display, a touch screen display, a keyboard or a mouse, or one or more memories, such as static random access memory, dynamic random access memory, flash memory, or a hard drive, although, again, claimed subject matter is not limited in scope to this example.

In the preceding description, various aspects of claimed subject matter have been described. For purposes of explanation, specific numbers, systems, or configurations may have been set forth to provide a thorough understanding of claimed subject matter. However, it should be apparent to one skilled in the art having the benefit of this disclosure that claimed subject matter may be practiced without those specific details. In other instances, features that would be understood by one of ordinary skill were omitted or simplified so as not to obscure claimed subject matter. While certain features have been illustrated or described herein, many modifications, substitutions, changes or equivalents may now occur to those skilled in the art. It is, therefore, to be understood that the appended claims are intended to cover all such modifications or changes as fall within the true spirit of claimed subject matter.

What is claimed is:

1. A method comprising:
displaying electronic content;
overlaying a zoom control with respect to at least a portion of said displayed electronic content; and
adjusting a zoom level of said electronic content in response to interaction with said zoom control,
wherein a rate of change of said zoom level of said electronic content is based, at least in part, on input received indicating a two-dimensional position of said zoom control at which the zoom control is operated.

2. The method of claim 1, wherein said zoom control comprises a radial zoom control, and wherein said rate of change of said zoom level is based, at least in part, on input indicating a radius of said zoom control at which the radial zoom control is operated.

3. The method of claim 2, wherein said rate of change of said zoom level of said electronic content is based, at least in part, on a rate at which the radial zoom control is operated.

4. The method of claim 2, wherein said interaction with said radial zoom control comprises a physical touching of at least a portion of a display displaying said electronic content.

5. The method of claim 2, wherein said radial zoom control comprises substantially one-quarter of a circle shape displayed in a corner of said displayed electronic content.

6. The method of claim 1, further comprising
expanding a size of said overlaid zoom control in response to input indicating a physical double-tapping or selection of a portion of a display including at least a portion of said zoom control.

7. The method of claim 1, wherein said electronic content comprises at least one of the following: an image; a document; a video; a map; or any portion or combination thereof.

8. The method of claim 1, further comprising
switching a location of said overlaid zoom control from one edge or corner of a display to another edge or corner of said display in response to input indicating a physical touching of a portion of said display.

9. The method of claim 1, further comprising
panning said displayed electronic content in response to input indicating a dragging of at least a portion of said displayed electronic content.

10. The method of claim 1, wherein said radial zoom control comprises a soft dial.

11. The method of claim 1, wherein said zoom control is at least one of partially translucent, fully translucent, or transparent with respective to underlying displayed electronic content.

12. A method comprising:
generating a zoom control to be displayed on a display of a device in connection with electronic content being viewed on said display, said zoom control appearing in a portion of said display relative to said electronic content being viewed,
wherein said portion is changeable in response to a selection of said zoom control on said display, and
wherein a rate of enlargement or reduction of said electronic content is based, at least in part, on input received indicating a two-dimensional position at which the zoom control is operated on said display.

13. The method of claim 12, wherein said zoom control comprises a radial zoom control, and wherein said rate of enlargement or reduction of said electronic content is based, at least in part, on input indicating a radius of said zoom control at which the radial zoom control is operated.

14. The method of claim 13, wherein said rate of enlargement or reduction of said electronic content is based, at least in part, on input indicating a rate at which the radial zoom control is operated on said display.

15. The method of claim 14, wherein said interaction with said radial zoom control comprises a physical touching of a portion of said display corresponding to said radial zoom control on said display.

16. An article comprising: a storage medium having stored thereon instructions executable by a processor to:
display electronic content;
overlay a zoom control on at least a portion of said displayed electronic content; and
adjust a zoom level of said electronic content in response to interaction with said zoom control,
wherein a rate of change of said zoom level of said electronic content is based, at least in part, on input received indicating a two-dimensional position of said zoom control at which the zoom control is operated.

17. The article of claim 16, wherein said instructions are further executable by said processor to overlay a radial zoom control, and to adjust said rate of change of said zoom level based, at least in part, on input indicating a radius of said zoom control at which the radial zoom control is operated.

18. The article of claim 17, wherein said instructions are further executable by said processor to adjust a rate of change of said zoom level of said electronic content based, at least in part, on a rate at which the radial zoom control is operated.

19. The article of claim 17, wherein said instructions are further executable by said processor to adjust said zoom level in response to a physical touching of at least a portion of a display displaying said electronic content

20. The article of claim 17, wherein said instructions are further executable by said processor to overlay said radial zoom control having a one-quarter circular shape in a corner of said displayed electronic content.
